(19) United States
(12) Patent Application Publication
(10) Pub. No.: US 2019/0011063 A1
(43) Pub. Date: Jan. 10, 2019

(54) FLUID CONDUIT COMPONENT AND METHOD FOR PRODUCING IT

(71) Applicant: Linde Aktiengesellschaft, Munich (DE)

(72) Inventors: Konrad BRAUN, Lenggries (DE); Stefan GEWALD, Munich (DE); Elise ESTIOT, Munich (DE); Manfred STEINBAUER, Raisting (DE); Ole MULLER-THORWART, Eichenau (DE)

(73) Assignee: Linde Aktiengesellschaft, Munich (DE)

(21) Appl. No.: 16/029,857

(22) Filed: Jul. 9, 2018

(30) Foreign Application Priority Data
Jul. 10, 2017 (EP) 17020288.1

(51) Int. Cl. F16L 9/00; F16L 55/07; B33Y 80/00

(52) U.S. Cl. CPC F16L 9/006; B33Y 80/00; F16L 55/07

(57) ABSTRACT

The invention relates to a fluid conduit component, designed to be flowed through by a fluid in a direction of flow. The fluid conduit component has a conduit wall, which extends along the direction of flow and at least partially forms a conduit channel. Furthermore, the fluid conduit component has at least one capillary, which at least partially runs along the direction of flow and within the conduit wall and is enclosed by said conduit wall and/or is arranged within a capillary module arranged on an inner side of the conduit wall facing the conduit channel and is enclosed by said capillary module. The conduit wall is in this case formed with the capillary running at least partially therein and/or with the capillary module at least partially by an additive manufacturing process. Furthermore, the invention relates to a method for producing a fluid conduit component.

The invention relates to a fluid conduit component and to a method for producing it, and consequently lies in particular in the technical area of pipelines and/or pressure-bearing components in the field of process engineering.

### PRIOR ART

In installations of the process engineering industry, knowledge of temperatures and/or temperature variations within the apparatuses concerned is often of great importance. In particular, precise knowledge of the temperature and/or the temperature variation and/or the pressure in the fluid conduit components in reactors and/or heat exchangers for example may be of crucial importance for safe operation and/or for an efficient process sequence. It is especially often the case that methods and/or processes taking place in such installations can be controlled in a closed-loop and/or open-loop manner all the more efficiently the more precisely the temperature and/or the temperature variation and/or the pressure in the apparatuses concerned is known. Furthermore, precise knowledge of the temperature and/or the temperature variation and/or the pressure in the process engineering installations may be advantageous for avoiding instances of thermal stress and/or overheating, and consequently for avoiding instances of damage.

Temperature measurements in such apparatuses are therefore of central technical importance. Often used in industry for measuring the temperature in apparatuses are local or locally attached temperature sensors, which measure the temperature at the point of the location where they are attached, and/or sensor cables measuring over an extended linear range, such as for instance fiber-optic cables.

Measuring the temperature of a material or some complexly shaped and/or inaccessibly arranged components, such as for instance tubes in a heat exchanger, often involves great technical difficulties. For this purpose, temperature sensors are often placed and/or adhesively attached on the outer side of the component to be monitored. However, this entails the disadvantage that the temperatures measured by the temperature sensors can be influenced by a fluid surrounding the components, and therefore the temperature measurements can under some circumstances be falsified.

Furthermore, sensors attached to the components can be damaged by a fluid surrounding the component.

The invention is therefore based on the object of providing a fluid conduit component that allows improved arrangement of sensors.

### DISCLOSURE OF THE INVENTION

This object is achieved by a fluid conduit component and a method for producing such a component with the features of the respective independent claims. Preferred embodiments are the subject of the dependent claims and the description that follows.

In a first aspect, the invention relates to a fluid conduit component which is designed to be flowed through by a fluid in a direction of flow. The fluid conduit component has a conduit wall, which extends along the direction of flow and at least partially forms a conduit channel. Furthermore, the fluid conduit component has at least one capillary, which at least partially runs along the direction of flow and within the conduit wall and is enclosed by said conduit wall and/or is arranged within a capillary module arranged on an inner side of the conduit wall facing the conduit channel and is enclosed by said capillary module. The conduit wall is in this case formed with the capillary running at least partially therein and/or with the capillary module at least partially by an additive manufacturing process.

In a further aspect, the invention relates to a method for producing a fluid conduit component, comprising forming a conduit wall enclosing a conduit channel, with at least one capillary running within the conduit wall and enclosed by the conduit wall and/or with a capillary module, which is arranged on an inner side of the conduit wall, in which the capillary runs and which encloses the capillary, the forming at least partially taking place by an additive manufacturing process.

The fluid conduit component may for example comprise a pipeline component and/or a nozzle or be formed as such.

The fluid may in this case comprise a liquid and/or gaseous fluid. In particular, the fluid in the conduit channel may be under a very great pressure, which may in particular be very much greater than a pressure on an outer side of the fluid conduit element.

The direction of flow is in this case the direction along which the flowing of the fluid through the fluid conduit component is intended. If a fluid conduit component is designed to be flowed through in both directions, i.e. in a first orientation or in an orientation opposite thereto, the opposite orientation may also apply as the direction of flow.

The conduit wall should be understood here as meaning the wall of the fluid conduit component. The conduit wall may in particular be tubularly formed, though a cross-sectional shape of the conduit wall or of the fluid conduit component can be designed to a great extent in any way desired. For example, the conduit wall may have a cross-sectional shape that remains the same or varies along the direction of flow. A wall thickness of the conduit wall may in this case likewise be designed as remaining the same or varying along the direction of flow and/or along the circumference of the cross section. For example, a wall thickness may be between 1 mm and 20 cm.

The conduit channel is preferably formed by the conduit wall alone or by the conduit wall together with other components. The conduit wall preferably encloses an internal volume or an internal space, which however may for example have openings along the direction of flow, the conduit channel preferably being formed by this internal volume.

The capillary is preferably an elongate clearance, which is preferably longer by a multiple than the dimensions of the capillary in the direction of its cross section. The capillary is preferably an elongate, thin clearance, the length of which is preferably at least 10 times, more preferably at least 50 times, still more preferably at least 100 times, even more preferably at least 500 times and most preferably at least 1000 times, longer than the dimensions of the capillary in the direction of the cross section or in diameter.

That the capillary runs “at least partially” along the direction of flow means here that the capillary does not have to run exclusively parallel to the direction of flow. For example, the capillary may be arranged helically around the conduit channel. Particularly preferably, however, the at least one capillary runs substantially parallel to the direction of flow, i.e. the capillary runs parallel to the direction of flow apart from possible deviations that may for example originate from the production process.

The capillary module may in this case be a module or an element in which the capillary runs. For example, the capillary module may be formed as a reinforcement of the conduit wall in which the capillary runs. The capillary module may preferably be arranged on a fluid conduit component and/or form a structural unit with it.

The additive manufacturing process may for example comprise 3D printing and/or SLM (selective laser melting) and/or SLS (selective laser sintering) or consist thereof.

The invention offers the advantage that, by means of the at least one capillary, sensor elements (temperature and/or pressure sensors) can be integrated directly in the fluid conduit component, in particular in the conduit wall, and consequently do not have to be attached to the outside of the fluid conduit component as in the prior art. The invention therefore allows measurements to be carried out directly in the fluid conduit component and for example a core temperature of the conduit wall of the fluid conduit component to be measured by means of a temperature sensor arranged there. As a result, the invention offers possibilities for measurements that cannot be realized by a conventional arrangement of sensors on an outer side of a fluid conduit component, since the core temperature of the conduit wall cannot always be determined unequivocally by a sensor arranged on the outer side. In other words, according to the invention a core temperature of the conduit wall can be measured independently of a temperature of a fluid that may be located outside the fluid conduit component for example by means of a temperature sensor element that is arranged in the capillary.

Furthermore, the invention offers the advantage that an element, such as for instance a sensor element, can be arranged in the at least one capillary in a protected manner, and as a result is not influenced by adverse conditions which under some circumstances prevail outside the fluid conduit component. For example, an element arranged in the at least one capillary, such as for instance a sensor element, may be protected by the conduit wall from any fluid flows that there are outside the conduit element.

In addition, an advantage of the invention is that the fluid conduit component can be provided with capillaries in the conduit wall, which cannot be realized by conventional production methods of conventional fluid conduit components. In particular, drilling and/or milling at least one capillary in a conduit wall in such a way that the conduit wall encloses the at least one capillary is typically not possible. By contrast, the invention allows the forming of at least one such capillary in the conduit wall, without substantially reducing a pressure stability or pressure resistance of the fluid conduit component. In particular, according to the invention it is not necessary to drill a bore in the conduit wall and/or to mill a slot in the conduit wall, in particular not to drill bores and/or mill slots that are much greater than the capillaries to be created. Consequently, the invention offers the advantage that capillaries which can be used for example as analysis channels can be arranged at locations or positions that are not accessible by conventional methods of production.

Furthermore, the invention offers the advantage that additional elements, such as for instance sensor elements, can also be integrated in the fluid conduit component or in the conduit wall already during the method of producing the fluid conduit component and/or can be introduced into the capillary after the production of the fluid conduit component has been completed. If the additional elements are to be integrated in the fluid conduit component already during the method of producing the fluid conduit component, it may be advantageous to provide the additional elements optionally with a protective enclosure if the additional elements comprise sensitive elements, such as for instance sensor elements. It is preferably possible as a result to avoid damage to the additional elements that could occur for example due to high temperatures and/or mechanical force effects during the method of producing the fluid conduit component.

Alternatively or in addition, the invention allows that capillaries running in the fluid conduit component can be provided in one or more capillary modules. Such capillary modules may for example be printed onto an already produced fluid conduit component by means of an additive manufacturing process and/or be printed along with the fluid conduit component during the production of the fluid conduit component. This also allows conventional fluid conduit components, which sometimes are not provided with at least one capillary, to be subsequently provided with at least one capillary running in at least one capillary module attached thereto. In this way, for example, the production costs for fluid conduit components with at least one capillary can also be reduced.

Preferably, the conduit wall is formed in one piece with the capillary at least partially running therein and/or with the capillary module. Particularly preferably, the conduit wall is produced in one piece by means of an additive manufacturing process. This offers the advantage that it is possible under some circumstances to dispense with complex machining steps resulting from the possibly required assembly of a number of individual components, and consequently possible to reduce production expenditure. Furthermore, this offers the advantage that the fluid conduit component can as a result preferably be formed with particularly great pressure stability, since preferably there are no interfaces and/or joins and/or contact points that could reduce the pressure stability. Preferably, the fluid conduit component is formed in such a way that the fluid conduit component withstands a positive pressure of at least 1 bar, more preferably at least 2 bar, still more preferably at least 10 bar, even more preferably at least 50 bar, even much more preferably at least 100 bar, most preferably at least 200 bar, on the inner side of the conduit wall in relation to an external pressure on an outer side of the conduit wall.

Preferably, the fluid conduit component has a plurality of capillaries, which at least partially run along the direction of flow and are arranged in the conduit wall and/or in one or more capillary module arranged on the inner side of the conduit wall. This offers the advantage that a number of capillaries can be provided for the provision of elements, such as for instance sensor elements, and consequently if need be a number of elements can be provided in the conduit wall. For example, the number of capillaries may be of different lengths, so that the elements in the respective capillaries can be positioned at different positions in the conduit wall along the direction of flow.

Preferably, the capillaries of the plurality of capillaries run substantially parallel to one another and/or parallel to the direction of flow. For example, the capillaries in the conduit wall may run helically around the conduit channel and/or run in a straight line along the direction of flow. This offers the advantage that the capillaries can be formed for different purposes, in particular for different sensors and/or measuring methods.

Preferably, the at least one capillary is connected to the conduit channel at at least one contact point. This offers the advantage that, for example, a sensor element arranged in the at least one capillary can be in fluid connection with the conduit channel at the contact point. This allows the effect be achieved that, for example, measurements can be carried out directly on a fluid flowing through the conduit channel by means of a sensor element protruding into the fluid at the contact point, the sensor element and/or a connecting line being led through the at least one capillary. For example, this may serve the purpose of measuring a pressure of the fluid flowing through the conduit channel, since the capillary preferably allows a pressure-stable connection between the fluid and a sensor element or pressure sensor arranged for example at an at other location in the capillary and/or at another end of the capillary. Furthermore, a change in the composition of matter of the fluid can preferably be measured by way of the at least one contact point while the fluid is flowing through the fluid conduit component. Moreover, this preferably allows new findings to be obtained for optimizing such apparatuses or such fluid conduit components and/or allows improved open-loop and/or closed-loop controllability of processes taking place therein.

Preferably, the fluid conduit component has at least one shielding element, which is formed on the inner side of the conduit wall and is arranged in such a way that the at least one shielding element shields the at least one contact point from the fluid flowing through the conduit channel in the direction of flow. For example, the shielding element may take the form of a cap and/or a projection and protrude into the conduit channel from the inner side of the conduit wall. Preferably, the at least one shielding element is arranged in such a way that one or more contact points are arranged close together on the side of the shielding element that is facing away from the flow. In other words, at least one contact point is in the “flow shadow” of the at least one shielding element. This offers the advantage that the contact point is at least not directly and/or at least not completely exposed to the stream of fluid in the conduit channel. For example, the shielding element makes it possible to avoid condensate forming and/or being deposited on a sensor element formed at the contact point and adversely affecting the function of the sensor element and/or the measurement.

Preferably, the forming of the conduit wall comprises integrating at least one sensor element in the at least one capillary. In particular, the at least one sensor element is already introduced or integrated into the capillary when the capillary, or the conduit wall with the capillary, and/or the capillary module is formed, in particular by means of an additive manufacturing process. This offers the advantage that the at least one sensor element can be arranged in positions or capillaries that are possibly not accessible, or only with great difficulty, after the completion of the capillary or the conduit wall or the capillary module.

Further advantages and configurations of the invention are evident from the description and the accompanying drawings.

It goes without saying that the features mentioned above and still to be explained below can be used not only in the respectively specified combination but also in other combinations or on their own without departing from the scope of the present invention.

The invention is schematically represented in the drawings on the basis of exemplary embodiments and is described below with reference to the drawings.

### DESCRIPTION OF THE FIGURES

FIG. 1A shows a fluid conduit component according to a first preferred embodiment in a schematic cross-sectional representation.

FIG. 1B shows a fluid conduit component according to a second preferred embodiment in a schematic cross-sectional representation.

FIG. 1C shows a fluid conduit component according to a third preferred embodiment in a schematic cross-sectional representation.

FIG. 2 shows a fluid conduit component according to a fourth preferred embodiment in a schematic longitudinal sectional representation.

FIGS. 3A and 3B show a fluid conduit component according to a fifth preferred embodiment in schematic representations.

FIG. 4 shows a fluid conduit component according to a sixth preferred embodiment in a schematic, perspective representation.

### DETAILED DESCRIPTION OF THE DRAWINGS

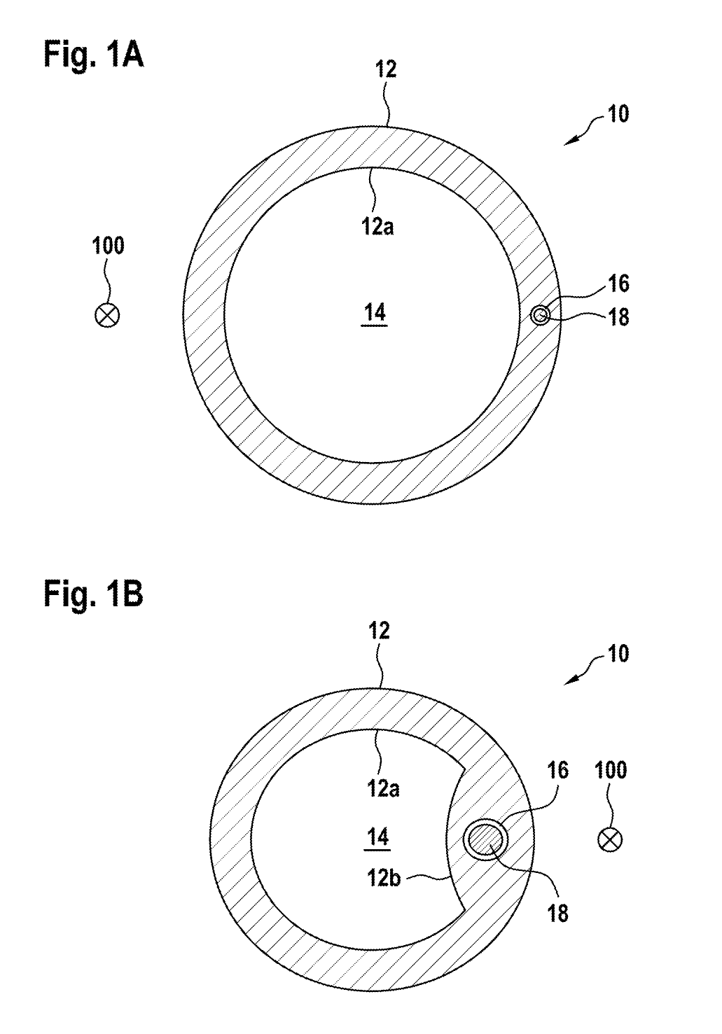

FIG. 1A shows a fluid conduit component 10 according to a first preferred embodiment of the invention in a schematic cross-sectional representation, the fluid conduit component 10 being formed as a pipeline. Even if the fluid conduit component 10 shown by way of example has a round cross section, other cross-sectional shapes and/or cross-sectional sizes are also possible. The fluid conduit component 10 has a conduit wall 12, which has a cylindrical cross section and forms a conduit channel 14 bounded by the inner side 12a of the conduit wall 12. The fluid conduit component 10 is in this case formed in such a way that a fluid can flow through the fluid conduit component 10 through the conduit channel 14 in a direction of flow 100. In particular, the fluid may in this case be under pressure and exert a pressure on the inner wall or inner side 12a of the conduit wall 12.

In addition, the fluid conduit component 10 has a capillary 16, which is formed centrally in the conduit wall 12 and runs parallel to the conduit wall 12 and to the direction of flow 100. The capillary 16 has in this case a round cross-sectional shape, even though other cross-sectional shapes are also possible. The cross section of the capillary 16 is in this case smaller than the wall thickness or thickness of the conduit wall 12, and the capillary 16 is arranged in relation to the conduit wall 12 in such a way that the conduit wall 12 encloses the capillary 16. In particular, the size of the cross section of the capillary 16 is much smaller than the thickness of the conduit wall 12, so that the conduit wall 12 has a sufficient pressure stability to allow the fluid to flow through the fluid conduit component 10 with the intended or desired pressure without damaging the fluid conduit component 10 or conduit wall 12. For example, the capillary 16 and the conduit wall 12 may be formed in such a way that the thickness of the conduit wall 12 is at least twice the cross section of the capillary 16 in the direction of the thickness of the conduit wall 12.

According to the embodiment shown, arranged in the capillary 16 is a sensor element 18, which runs within the capillary 16 along the direction of flow 100, and is consequently enclosed by the conduit wall 12.

FIG. 1B shows a fluid conduit component 10 according to a second preferred embodiment in a cross-sectional representation. This differs from the embodiment shown in FIG. 1A in particular in that the diameter of the capillary 16 is greater in relation to the thickness of the conduit wall 12. In order nevertheless to ensure that the conduit wall 12 or the fluid conduit component 10 has the desired properties with respect to pressure stability, i.e. that the fluid conduit component 10 withstands the desired or intended pressure of the fluid, the conduit wall 12 has on the inner side 12a a reinforcing portion 12b, which together with the remaining conduit wall 12 embeds the capillary 16. This consequently allows even large ratios of the capillary diameter in relation to the thickness of the conduit wall 12 to be realized without having to accept disadvantages with respect to a pressure resistance of the fluid conduit component 10. Preferably, the fluid conduit component 10 is formed with the reinforcing portion 12b and the capillary 16 already during production, in particular by means of an additive manufacturing process, for example using a 3D printer.

FIG. 1C shows a fluid conduit component 10 according to a third preferred embodiment in a cross-sectional representation. According to this embodiment, the capillary 16 does not run directly in the conduit wall 12, but runs in an additionally formed capillary module 20. The capillary module 20 in this case comprises a printing compound 22, which is preferably printed directly on the inner side 12a of the conduit wall 12 and connected to it. For example, it is conceivable that the capillary module 20 can be printed onto the inner side of the conduit wall 12 at a later time, i.e. after production of the conduit wall 12 has taken place, and consequently a fluid conduit component 10 that is initially formed without capillaries 16 is supplemented with a capillary module 20 and at least one capillary 16. According to other preferred embodiments (not shown), for example, capillaries 16 running in the conduit wall 12 may be combined with a capillary module 20 and capillaries 16 running therein in a fluid conduit component 10.

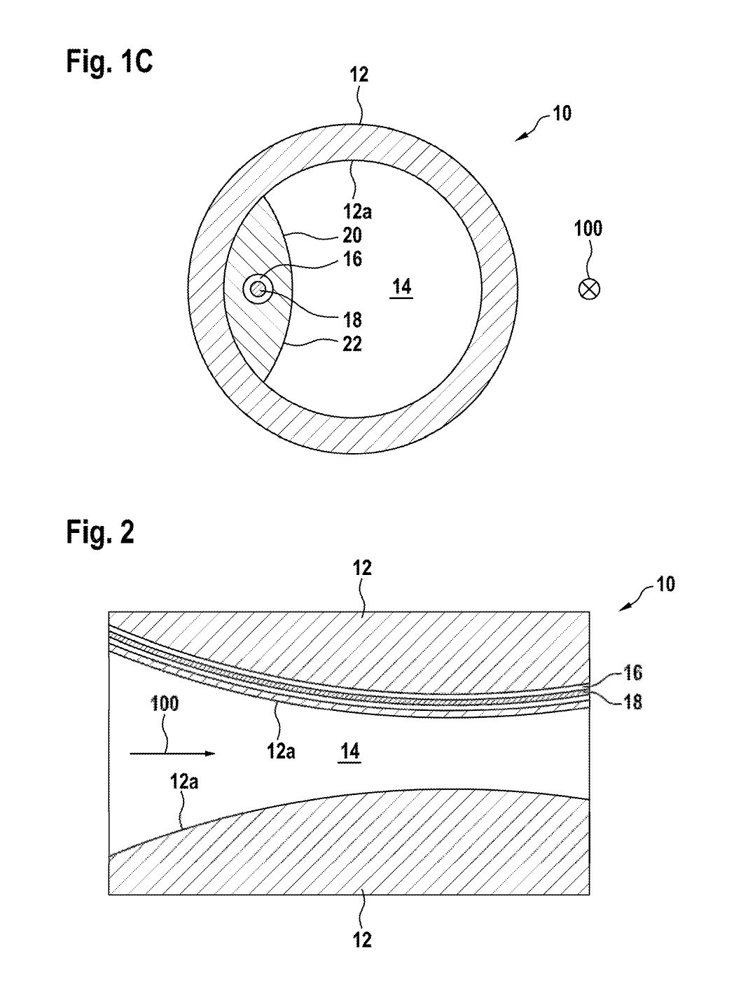

FIG. 2 shows a fluid conduit component 10 according to a fourth preferred embodiment in a longitudinal sectional representation, the fluid conduit component 10 being formed as a nozzle. The nozzle is in this case designed in such a way that a fluid under high pressure can flow through the nozzle along the direction of flow 100. Also according to this preferred embodiment, in the side wall 12 there is formed a capillary 16, which runs along the nozzle or along the direction of flow 100. Formed in the capillary 16 is a sensor element 18, for example a temperature sensor, with which the temperature in the core of the side wall 12 can be measured.

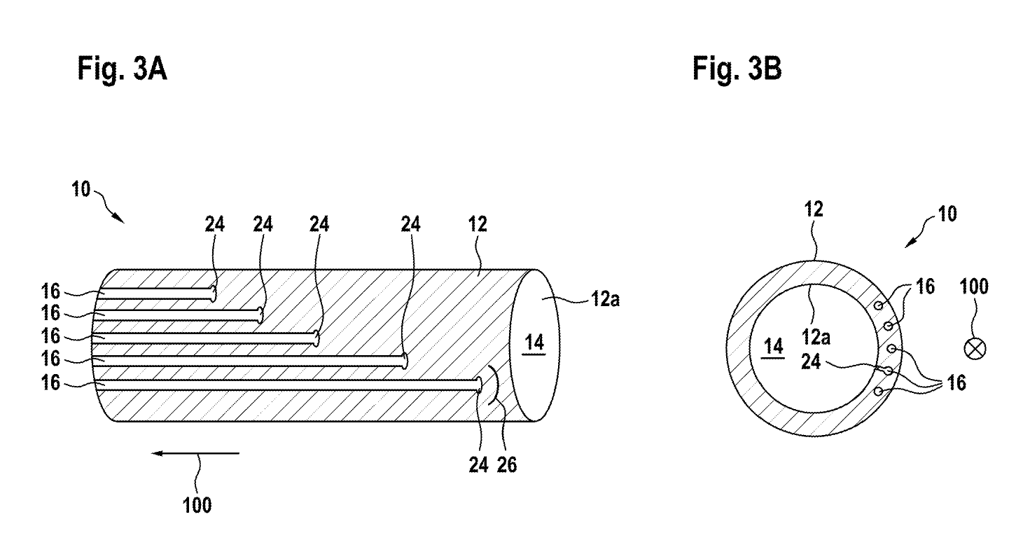

FIGS. 3A and 3B show in a schematic representation a fluid conduit component 10 according to a fifth preferred embodiment in a schematic, perspective representation (FIG. 3A) and in a cross-sectional representation (FIG. 3B). According to this preferred embodiment, in the conduit wall 12 there are formed a number of capillaries 16, which run parallel to one another and parallel to the direction of flow 100. The capillaries 16 have different lengths in each case and end in different portions of the fluid conduit component 10 or of the conduit wall 12 along the direction of flow 100. At the respective ends of the capillary 16 there are formed contact points 24, at which the capillaries 16 are connected to the inner side 12a of the conduit wall 12 or to the conduit channel 14. This allows measurements, for example with sensor elements (not shown) which are arranged in the respective capillaries 16, to be performed in the conduit channel 14 in the respective portions of the fluid conduit component 10 in which the capillaries 16 are connected to the conduit channel 14 by way of the contact points 24, in order to perform measurements in the flowing fluid in different locations along the direction of flow 100. For example, in this way a pressure variation and/or temperature variation and/or a variation in the composition of matter of the fluid flowing through the fluid conduit component can be measured along the direction of flow 100. For example, a direct material-based connection by way of the contact points 24 allows a chemical and/or physical analysis of the fluid, for example by means of a gas chromatograph. This may be advantageous in particular for the use of such a fluid conduit component 10 in a tubular reactor, in order for example to be able to measure a chemical reaction as it progresses along the fluid conduit component 10.

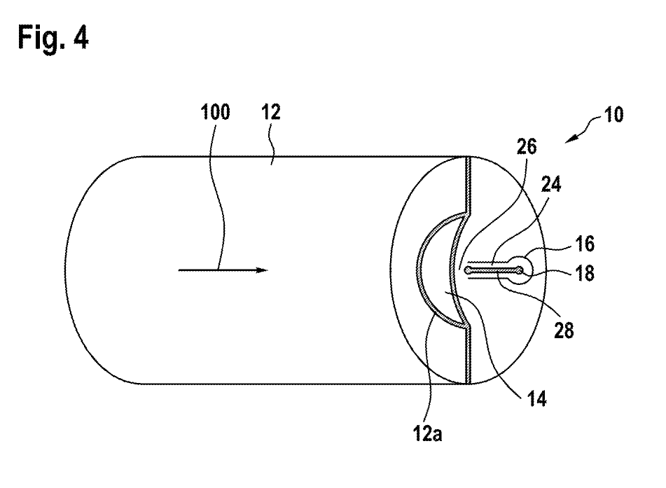

Furthermore, symbolically represented in FIG. 3A is a shielding element 26, which is arranged in such a way that the contact point 24 of the capillary 16 shown at the bottom is at least partially shielded from a fluid flowing through the conduit channel 14 in the direction of flow 100, for example in order to bring about the effect that a sensor element (not shown) arranged at the contact point 24 is not exposed directly to the fluid. Further details of the shielding element are explained with reference to FIG. 4.

A fluid conduit component 10 according to this embodiment may for example be advantageous to measure a pressure loss profile of the fluid flowing through the fluid conduit component in a reliable way. If the fluid conduit component 10 is used as a reaction chamber and/or in a tubular reactor, preferably a progression or sequence of a chemical reaction taking place therein can be measured, for example by means of a substance analysis. Furthermore, a change in the composition of matter of the fluid can preferably be measured while the fluid is flowing through the fluid conduit component 10. Moreover, this allows new findings to be obtained for optimizing such apparatuses or the fluid conduit components 10 and/or allows improved open-loop and/or closed-loop controllability of processes taking place therein.

In particular, each of the capillaries 16 may be provided with a sensor element 18. For example, each of the capillaries 16 may have a temperature sensor and/or a pressure sensor and/or some other physical or chemical sensor. The sensor elements 18 may then be read at the same time and/or sequentially one after the other in time.

FIG. 4 shows a fluid conduit component 10 according to a sixth preferred embodiment in a schematic, perspective representation. In this case, the fluid conduit component 10 has a shielding element 26, which in the form of a projection protrudes from the inner side 12a of the conduit wall 12 into the conduit channel 14, in order in this way to shield a sensor element 18 positioned at a contact point 24 arranged downstream thereof in the direction of flow 100, and in particular the sensor head 28 arranged at the contact point 24, from the fluid flow. This allows for example the sensor head 28 positioned at the contact point 24 to be protected from direct exposure to the fluid.

In particular, the shielding element 26 may be designed and/or arranged in such a way that an optimized measuring method can be carried out by means of a sensor head 28 arranged at the associated contact point 24. For example, a fluid conduit component 10 as shown in FIG. 4 may be particularly advantageous for a temperature measurement in a fluid conduit component 10 that is formed in a gas line. If, for example, the fluid conduit component is flowed through by a superheated gas as fluid, which also brings about droplet entrainment, the shielding element 26 can protect the sensor element 18 arranged at the contact point 24 from droplets entrained by the fluid being deposited or settling on the sensor head 28 or wetting the sensor head 28. The shielding element consequently allows a reliable measurement of the temperature of the gaseous fluid to be performed by means of the sensor element 18 without the temperature measurement being impaired by entrained liquid fluid, which would otherwise be the case, for example due to evaporation of droplets impinging on the sensor element 18, in which case only the cooling limit temperature would be measured.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding application No. EP 17020288.1, filed Jul. 10, 2017 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

### REFERENCE SIGNS

10 Fluid conduit component
12 Conduit wall
12a Inner side of the conduit wall
12b Reinforcing portion
14 Conduit channel
16 Capillary
18 Sensor element
20 Capillary module
22 Printing compound
24 Contact point
26 Shielding element
28 Sensor head

1. Fluid conduit component (10), which is designed to be flowed through by a fluid in a direction of flow (100), having
a conduit wall (12), which extends along the direction of flow (100) and at least partially forms a conduit channel (14);
at least one capillary (16), which at least partially runs along the direction of flow (100) and within the conduit wall (12) and is enclosed by said conduit wall and/or is arranged within a capillary module (20) arranged on an inner side (12a) of the conduit wall (12) facing the conduit channel (14) and is enclosed by said capillary module;
the conduit wall (12) being formed with the capillary (16) running at least partially therein and/or with the capillary module (20) at least partially by an additive manufacturing process.

2. Fluid conduit component (10) according to claim 1, the conduit wall (12) being formed in one piece with the capillary (16) at least partially running therein and/or with the capillary module (20).

3. Fluid conduit component (10) according to claim 1, having a plurality of capillaries (16), which at least partially run along the direction of flow (100) and are arranged in the conduit wall (12) and/or in one or more capillary module (20) arranged on the inner side (12a) of the conduit wall (12).

4. Fluid conduit component (10) according to claim 3, the capillaries (16) of the plurality of capillaries (16) running substantially parallel to one another and/or parallel to the direction of flow (100).

5. Fluid conduit component (10) according to claim 1, the at least one capillary (16) being connected to the conduit channel (14) at at least one contact point (24).

6. Fluid conduit component (10) according to claim 5, also comprising a shielding element (26), which is formed on the inner side (12a) of the conduit wall and is arranged in such a way that the shielding element (26) shields the at least one contact point (24) from the fluid flowing through the conduit channel (14) in the direction of flow (100).

7. Fluid conduit component (10) according to claim 1, at least one sensor element (18) being arranged in the at least one capillary (16).

8. Fluid conduit component (10) according to claim 1, the fluid conduit component (10) being formed in such a way that the fluid conduit component (10) withstands a positive pressure of at least 1 bar on the inner side (12a) of the conduit wall (12) in relation to an external pressure on an outer side of the conduit wall (12).

9. Fluid conduit component (10) according to claim 1, the fluid conduit component (10) being formed as a pipeline component and/or as a nozzle.

10. Method for producing a fluid conduit component (10), comprising forming a conduit wall (12) enclosing a conduit channel (14), with at least one capillary (16) running within the conduit wall (12) and enclosed by the conduit wall (12) and/or with a capillary module (20), which is arranged on an inner side (12a) of the conduit wall (12), in which the capillary (16) runs and which encloses the capillary (16), the forming at least partially taking place by an additive manufacturing process.

11. Method according to claim 10, the forming of the conduit wall (12) comprising integrating at least one sensor element (18) in the at least one capillary (16).
